(19) United States
(12) Patent Application Publication
(10) Pub. No.: US 2006/0103777 A1
(43) Pub. Date: May 18, 2006

(54) Optical film having a structured surface with rectangular based prisms

(75) Inventors: Byungsoo Ko, Hwasung-City (KR); Dongwon Chae, Hwasung-shi (KR); Leland R. Whitney, St. Paul, MN (US); Mark E. Gardiner, Santa Rosa, CA (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/989,161

(22) Filed: Nov. 15, 2004

(51) Int. Cl. G02F 1/1335

(52) U.S. Cl. 349/65

(57) ABSTRACT

Described is an optical film having a structured surface including a plurality of prismatic structures. Each prismatic structure has a base including at least two longer sides disposed opposite to each other along a first general direction and at least two shorter sides disposed opposite to each other along a second general direction. The body transmits light incident thereon along the first general direction when an angle of incidence is within a first predetermined angle range with respect to the axis and reflects light when the angle of incidence is outside the first predetermined angle range. The body transmits light incident thereon along the second general direction when an angle of incidence is within a second predetermined angle range with respect to the axis and reflects light when the angle of incidence is outside the second predetermined angle range. The optical film further includes a substrate portion having an additional optical characteristic different from an optical characteristic of the structured surface. Display devices including such optical films are also disclosed.

### FIELD OF INVENTION

The invention relates generally to light-transmissive optical films and in particular, to optical films with rectangular-based prisms.

### BACKGROUND INFORMATION

Display devices, such as liquid crystal display (“LCD”) devices, are used in a variety of applications including, for example, televisions, hand-held devices, digital still cameras, video cameras, and computer monitors. An LCD offers several advantages over a traditional cathode ray tube (“CRT”) display such as decreased weight, unit size and power consumption, as well as increased brightness. However, an LCD panel is not self-illuminating and, therefore, requires a backlighting assembly or a “backlight.” A backlight typically couples light from a substantially linear source (e.g., a cold cathode fluorescent tube (“CCFT”)) or light emitting diode (“LED”) to a substantially planar output. The planar output is then coupled to the LCD panel.

The performance of an LCD is often judged by its brightness. Brightness of an LCD may be enhanced by using more or brighter light sources. In large area displays it is often necessary to use a direct-lit type LCD backlight to maintain brightness, because the space available for light sources grows linearly with the perimeter while the illuminated area grows as the square of the perimeter. Therefore, LCD televisions typically use a direct-lit backlight instead of a light-guide edge-lit type LCD backlight. Additional light sources and/or a brighter light source may consume more energy, which is counter to the ability to decrease the power allocation to the display device. For portable devices this may correlate to decreased battery life. Also, adding a light source to the display device may increase the product cost and sometimes can lead to reduced reliability of the display device.

Brightness of an LCD may also be enhanced by efficiently utilizing the light that is available within the LCD device (e.g., to direct more of the available light within the display device along a preferred viewing axis). For example, Vikuiti™ Brightness Enhancement Film (“BEF”), available from 3M Corporation, has prismatic surface structures, which redirect some of the light exiting the backlight outside the viewing range to be substantially along the viewing axis. At least some of the remaining light is recycled via multiple reflections of some of the light between BEF and reflective components of the backlight, such as its back reflector. This results in optical gain substantially along the viewing axis, and also results in improved spatial uniformity of the illumination of the LCD. Thus, BEF is advantageous, for example, because it enhances brightness and improves spatial uniformity. For a battery powered portable device, this may translate to longer running times or smaller battery size, and a display that provides a better viewing experience.

### SUMMARY

The present disclosure is directed to an optical film including a body having an axis and a structured surface including a plurality of prismatic structures, each prismatic structure having a base comprising at least two longer sides disposed opposite to each other along a first general direction and at least two shorter sides disposed opposite to each other along a second general direction. The body transmits a substantial portion of light incident thereon along the first general direction when an angle of incidence is within a first predetermined angle range with respect to the axis and reflects a substantial portion of light when the angle of incidence is outside the first predetermined angle range. The body further transmits a substantial portion of light incident thereon along the second general direction when an angle of incidence is within a second predetermined angle range with respect to the axis and reflects a substantial portion of light when the angle of incidence is outside the second predetermined angle range. The optical film further comprises a substrate portion having an additional optical characteristic different from an optical characteristic of the structured surface.

The present disclosure is also directed to a display device including a case having a window; a backlight situated in the case, an optical film situated between the backlight and the window; and a light valve arrangement situated between the optical film and the optical window. The optical film includes a body having an axis and a structured surface including a plurality of prismatic structures, each prismatic structure having a base including two longer sides disposed opposite to each other along a first general direction and two shorter sides disposed opposite to each other along a second general direction. The body transmits a substantial portion of light incident thereon along the first general direction when an angle of incidence is within a first predetermined angle range with respect to the axis and reflects a substantial portion of light when the angle of incidence is outside the first predetermined angle range. The body further transmits a substantial portion of light incident thereon along the second general direction when an angle of incidence is within a second predetermined angle range with respect to the axis and reflects a substantial portion of light when the angle of incidence is outside the second predetermined angle range. The optical film further comprises a substrate portion having an additional optical characteristic different from an optical characteristic of the structured surface.

### BRIEF DESCRIPTION OF DRAWINGS

So that those of ordinary skill in the art to which the subject invention pertains will more readily understand how to make and use the subject invention, exemplary embodiments thereof are described in detail below with reference to the drawings, wherein:

FIG. 1A shows schematically a flat light-guide edge-lit LCD backlight;

FIG. 1B shows schematically a wedge light-guide edge-lit LCD backlight;

FIG. 1C shows schematically an LCD backlight utilizing an extended light source;

FIG. 1D shows schematically a direct-lit type LCD backlight;

FIG. 2A shows schematically an exemplary embodiment of an optical film according to the present disclosure positioned over an LCD backlight;

FIG. 3A shows schematically an isometric view of an exemplary embodiment of an optical film according to the present disclosure;

FIG. 3B shows schematically a cross-sectional view of the optical film illustrated in FIG. 3A;

FIG. 4A shows schematically an isometric view of another exemplary embodiment of an optical film according to the present disclosure;

FIG. 4B shows schematically a cross-sectional view of the optical film illustrated in FIG. 4A;

FIG. 5A shows schematically an isometric view of a further exemplary embodiment of an optical film according to the present disclosure;

FIG. 5B shows schematically a cross-sectional view of the optical film illustrated in FIG. 5A;

FIG. 6A shows schematically a top view of a rectangular-based prism of an exemplary optical film according to the present disclosure;

FIG. 6B shows schematically a cross-sectional view of the prism illustrated in FIG. 6A;

FIG. 6C shows schematically another cross-sectional view of the prism illustrated in FIG. 6A;

FIG. 7A shows schematically a cross-sectional view of a rectangular-based prism of an exemplary optical film according to the present disclosure, positioned over an LCD backlight;

FIG. 7B shows schematically another cross-sectional view of the prism illustrated in FIG. 7A;

FIG. 8A shows schematically a top view of a rectangular-based prism of an exemplary optical film according to the present disclosure;

FIG. 8B shows schematically a top view of another rectangular-based prism of an exemplary optical film according to the present disclosure;

FIG. 9A shows schematically an isometric view of a further exemplary embodiment of an optical film according to the present disclosure;

FIG. 9B shows a polar iso-candela plot for the optical film illustrated in FIG. 9A;

FIG. 9C shows a rectangular candela distribution plot for the optical film illustrated in FIG. 9A;

FIG. 10A shows schematically an isometric view of a further exemplary embodiment of an optical film according to the present disclosure;

FIG. 10B shows a polar iso-candela plot for the optical film illustrated in FIG. 10A;

FIG. 10C shows a rectangular candela distribution plot for the optical film illustrated in FIG. 10A;

FIG. 11A shows schematically an isometric view of a further exemplary embodiment of an optical film according to the present disclosure;

FIG. 11B shows a polar iso-candela plot for the optical film illustrated in FIG. 11A; and

FIG. 11C shows a rectangular candela distribution plot for the optical film illustrated in FIG. 11A.

### DETAILED DESCRIPTION

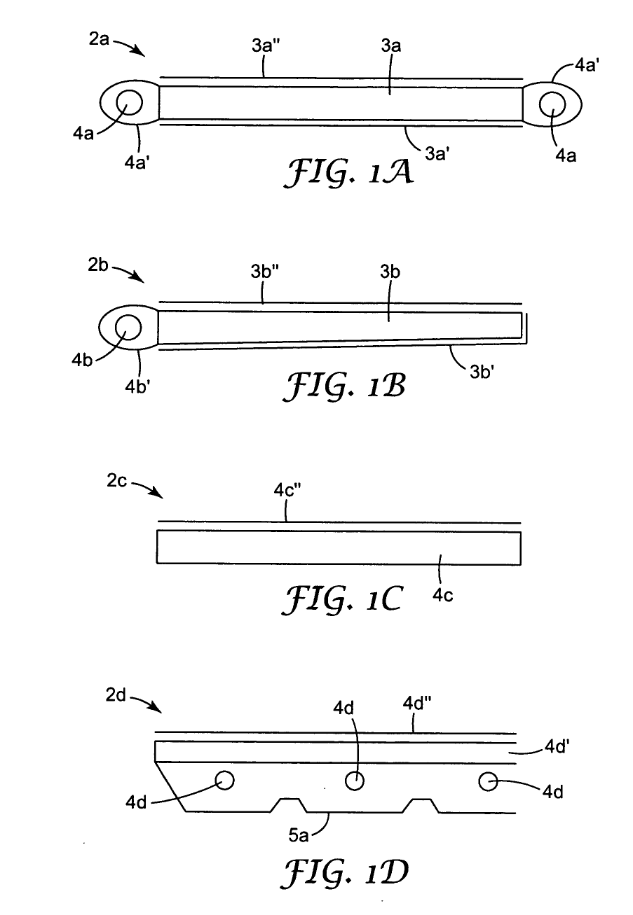

The present disclosure is directed to an optical film for controlling the distribution of light from a light source and, in particular, for controlling light distribution along two different directions. The optical film according to the present disclosure may be useful in controlling the light distribution for an LCD backlight (e.g., LCD backlights shown in FIGS. 1A-1D).

FIGS. 1A-1D show several examples of backlights that may be used in LCDs. FIG. 1A shows a backlight 2a. The backlight 2a includes two light sources 4a, such as two cold cathode fluorescent tubes (“CCFT”), that provide light from opposite sides or edges of the backlight, lamp reflectors 4a′ disposed about the light sources 4a, a lightguide 3a, which is illustrated as a substantially planar lightguide, a back reflector 3a′ and optical films 3a″, which may be any suitable optical films. FIG. 1B shows a backlight 2b including a single light source 4b, such as a CCFT, a lamp reflector 4b′ disposed about the light source 4b, a lightguide 3b, which is illustrated as a wedge-shaped lightguide, a back reflector 3b′ and optical films 3b″, which may be any suitable optical films. FIG. 1C shows a backlight 2c, which includes an extended light source 4c. Exemplary suitable extended light sources include surface emission-type light sources. FIG. 1D shows schematically a partial view of a backlight 2d, which includes three or more elongated linear light sources (e.g. CCFTs) 4d, a back reflector 5a, a diffuser plate 4d′ and optical films 4d″, which may be any suitable optical films.

Such backlights may be used in various display devices, such as LCD devices (e.g., televisions, monitors, etc). As one of ordinary skill in the art will understand, a display device may include a case having a window, a backlight situated in the case, an optical film according to the present disclosure, other suitable optical films, and a light valve arrangement, such as an LCD panel, situated between the optical film and the optical window. The optical film according to the present disclosure also may be used in conjunction with any other light source known to those of ordinary skill in the art and may include any other suitable elements.

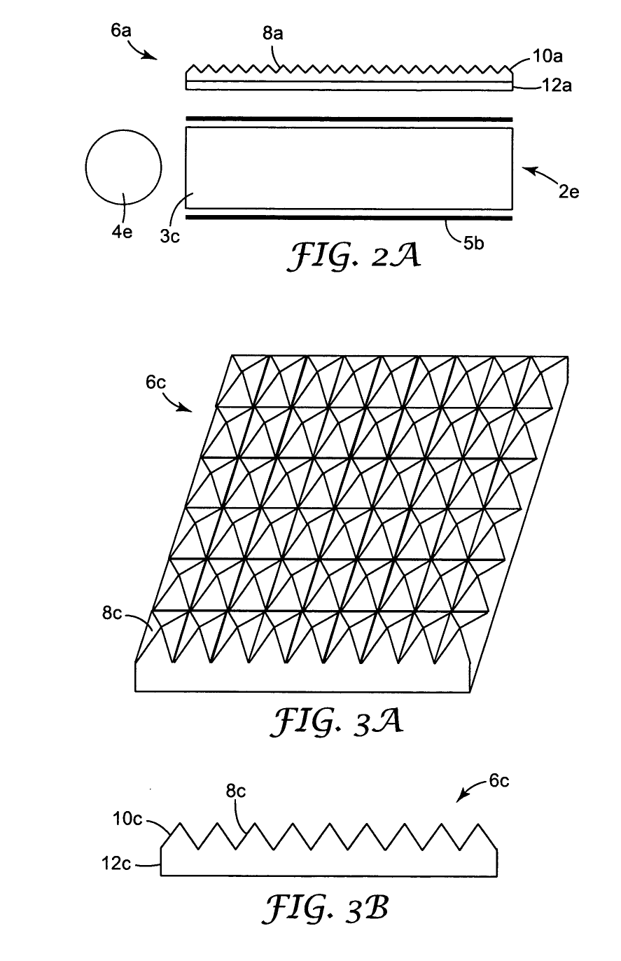

FIG. 2A shows a cross-sectional view of a backlight 2e and an optical film 6a according to the present disclosure. The backlight 2e may include a light source 4e, a lightguide 3c, and a back reflector 5b. The optical film 6a may be positioned above the backlight 2e. The optical film 6a according to the present disclosure has a body that includes a structured surface 10a and a substrate portion 12a. The body of the optical film 6a may be characterized by an axis, which in some exemplary embodiments is substantially perpendicular to the substrate portion 12a and in other exemplary embodiments the axis makes a different angle with respect to the substrate portion 12a.

In typical embodiments of the present disclosure, the body axis is substantially collinear with a viewing direction of a display device in which the optical films of the present disclosure can be used. The structured surface 10a includes a plurality of prismatic structures 8a, such as pyramidal prisms, which in some exemplary embodiments are rectangular-based prisms. The prismatic structures 8a are arranged on the structured surface 10a, in close proximity to one another, and, in some exemplary embodiments, in substantial contact or immediately adjacent with one another. However, in other exemplary embodiments, the prismatic structures 8a may be spaced from each other at any suitable distance (e.g., about ten (10) microns or more) provided that the gain of the optical film 6a is at least about 1.1.

For the purposes of the present disclosure, “gain” is defined as the ratio of the axial output luminance of an optical system with an optical film constructed according to the present disclosure to the axial output luminance of the same optical system without such optical film. In typical embodiments of the present disclosure, the size, shape and angles of the prismatic structures are selected to provide an optical gain of at least about 1.1. In addition, the spacing, size, shape and angles of the prismatic structures may be selected based on the desired output distribution of light. However, the prismatic structures should not be so small as to cause diffraction and should not be so large as to be seen with an unaided eye. The latter typically occurs for structures of about 100 micron in size. In some exemplary embodiments that are particularly suitable for use in direct-lit backlights, the spacing, size, shape and angles of the prismatic structures can be chosen so that the optical films of the present disclosure aid in hiding from the viewer light sources used in a direct-lit backlight. In the exemplary embodiment shown in FIG. 2A, the structured surface 10a is disposed on the substrate portion 12a. As one of ordinary skill in the art would understand, the optical film 6a may be used to change the direction and, in some cases, other characteristics of light rays emitted from the backlight 2e. For example, some embodiments of the present disclosure allow for the control of the angular spread of light using the prismatic structures 8a of the optical film 6a.

The substrate portion 12a has an additional optical characteristic that is different from the optical characteristics of the structured surface 10a, such that the substrate portion manipulates light in a way that is different from the way light is manipulated by the structured surface 10a. Such manipulation may include polarization, diffusion or additional redirection of light entering the optical films of the present disclosure. This may be accomplished, for example, by including in the substrate portion an optical film having such an additional optical characteristic or constructing the substrate portion itself to impart such an additional optical characteristic. Exemplary suitable films having such additional optical characteristics include, but are not limited to, a polarizer film, a diffuser film, a brightness enhancing film such as BEF, a turning film and any combination thereof. Turning film may be, for example, a reversed prism film (e.g., inverted BEF) or another structure that redirects light in a manner generally similar to that of a reversed prism film. In some exemplary embodiments, the substrate portion 12a may include a multilayer reflective polarizer, such as Vikuiti™ Dual Brightness Enhancement Film (“DBEF”), or a diffuse reflective polarizer having a continuous phase and a disperse phase, such as Vikuiti™ Diffuse Reflective Polarizer Film (“DRPF”), both available from 3M Company. In other exemplary embodiments, the substrate portion may include a polycarbonate layer (“PC”), a poly methyl methacrylate layer (“PMMA”), a polyethylene terephthalate (“PET”) or any other suitable film or material known to those of ordinary skill in the art.

FIGS. 3A and 3B show an exemplary embodiment of an optical film 6c according to the present disclosure. A structured surface 10c and a substrate portion 12c may be parts of a single film, as shown in FIGS. 3A and 3B. As one of ordinary skill in the art would understand, the structured surface 10c and the substrate portion 12c may be formed as a single part, and in some cases from the same material, to produce the optical film 6c, or they may be formed separately and then joined together to produce a single part, for example, using a suitable adhesive. The optical film 6c may be manufactured by any method known to those of ordinary skill in the art including, but not limited to, embossing, casting, compression molding, and batch processes.

In an exemplary method of manufacturing an optical film according to the present disclosure, a micro-structured form tool, and optionally an intermediate form tool, may be utilized to form the optical film (e.g. optical film 6c). The micro-structured form tool may be made, for example, by cutting groves in two directions on a suitable substrate. As one of ordinary skill in the art will understand, the resultant micro-structured form tool will include a plurality of prismatic structures resembling the desired optical film. The depth of the cut and spacing between each parallel cut may be adjusted depending on whether prismatic structures with sharp points, flats, or sharp lines along the peaks are desired and depending on other relevant parameters.

An intermediary form tool with a reverse or opposite structure to the micro-structured form tool (e.g. inverted prismatic structures) may be manufactured from the micro-structured form tool using, for example, an electro-plating method or polymer replication. The intermediary form tool may be comprised of polymers including, for example, polyurethane, polypropylene, acrylic, polycarbonate, polystyrene, a UV cured resin, etc. The intermediate tool may also be coated with a release layer in order to facilitate release of the final optical film.

As one of ordinary skill in the art will understand, the intermediary form tool may be used to manufacture the optical film (e.g. optical film 6c) via direct replication or a batch process. For example, the intermediary form tool may be used to batch process the optical film 6c by such methods as injection molding, UV curing, or thermoplastic molding, such as compression molding. The optical film according to the present disclosure may be formed of or include any suitable material known to those of ordinary skill in the art including, for example, inorganic materials such as silica-based polymers, and organic materials, such as polymeric materials, including monomers, copolymers, grafted polymers, and mixtures or blends thereof.

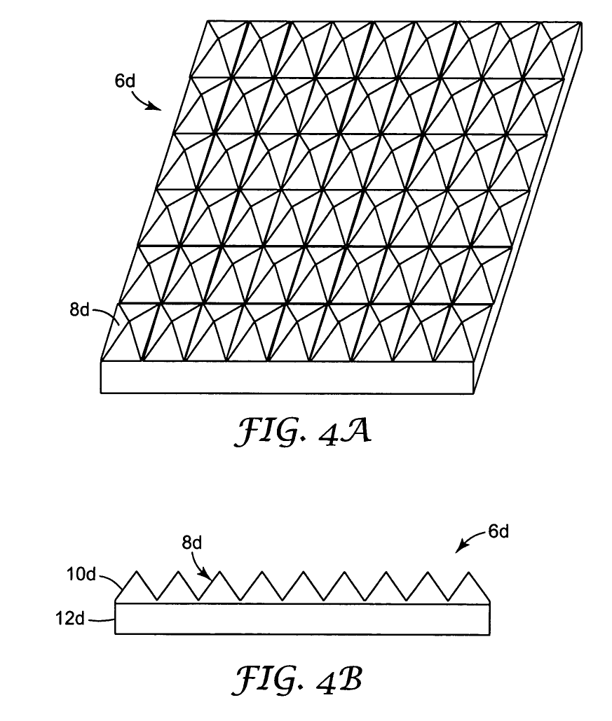

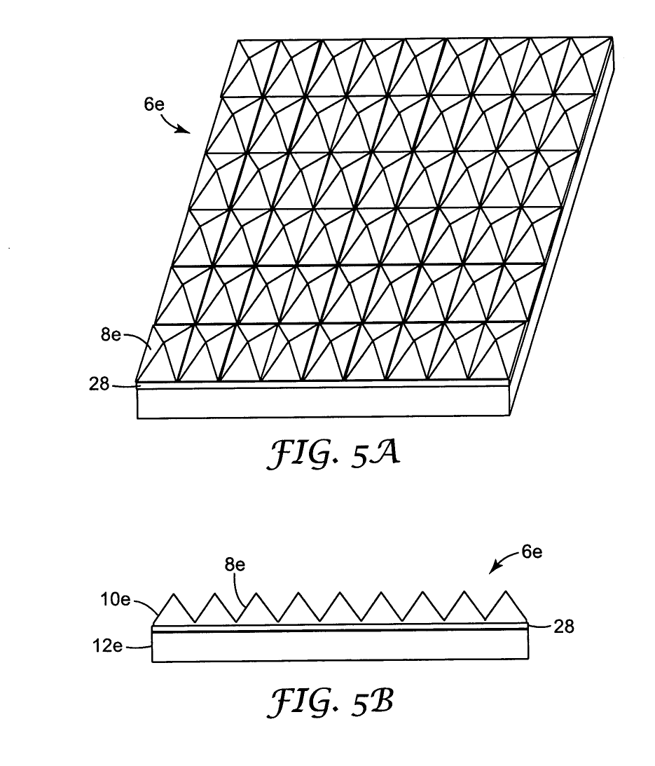

FIGS. 4A and 4B show another exemplary embodiment of an optical film 6d according to the present disclosure. In particular, the optical film 6d may be formed from two separate portions: a portion having a structured surface 10d and a substrate portion 12d. Such exemplary embodiments may be produced, for example, by coating the substrate portion with a curable material, imparting the structured surface into the curable material, and curing the optical film. Alternatively, a portion having a structured surface 10e and a substrate portion 12e of an optical film 6e may be two separate films bonded together with a suitable adhesive 28, for example, as illustrated in FIGS. 5A and 5B. The adhesive 28 may include, but is not limited to, a pressure sensitive adhesive (PSA) or an ultraviolet (UV) light curable adhesive. In such exemplary embodiments, it is sometimes advantageous to make the portion having a structured surface from a material with a refractive index lower than the refractive index of the substrate portion.

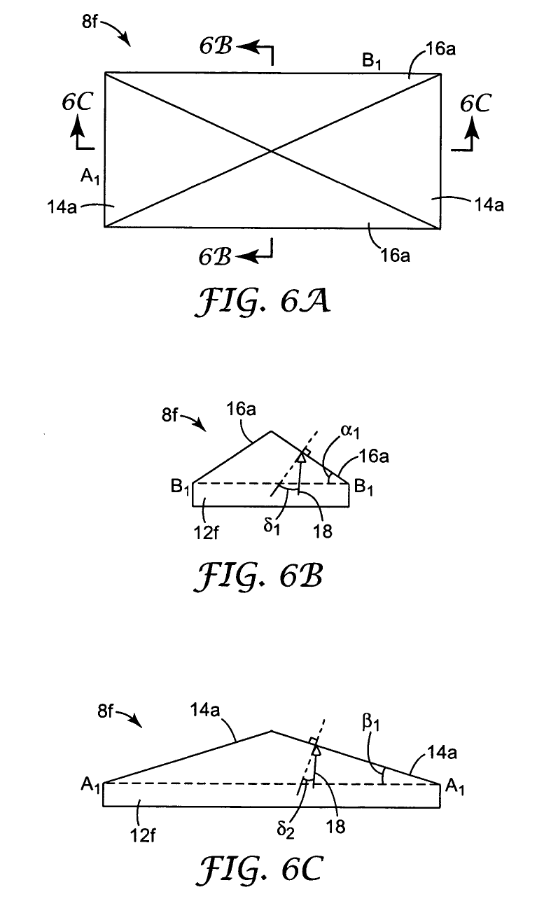

An exemplary embodiment of prismatic structures 8f according to the present disclosure is shown in FIGS. 6A-6C. FIG. 6A shows a top view of a prismatic structure 8f. The base of the prismatic structure 8f may be a four-sided shape with two first sides A₁, disposed generally opposite to each other along a direction shown as 6C, and two second sides B₁, disposed generally opposite to each other along a direction shown as 6B. In typical embodiments of the present disclosure, the length of A₁ is less than the length of B₁, the two first sides A₁ are substantially parallel to each other, and the two second sides B₁ are substantially parallel to each other. In some exemplary embodiments, the first sides A₁ are substantially perpendicular to the second sides B₁. Thus, the base of the prismatic structure 8f may be substantially rectangular.

FIG. 6B shows a cross-sectional view of an exemplary embodiment of a prismatic structure 8f in the 6B-6B plane as shown in FIG. 6A. The prismatic structure 8f includes two surfaces 16a. The prismatic structure 8f also includes an angle α₁ (alpha) measured between one of the surfaces 16a and a plane parallel to a substrate portion 12f. FIG. 6C shows a cross-sectional view of an exemplary embodiment of the prismatic structure 8f in the 6C-6C plane as shown in FIG. 6A. The prismatic structure 8f comprises two surfaces 14a. The prismatic structure 8f also includes an angle β₁ (beta) measured between one of the surfaces 14a and a plane parallel to the substrate portion 12f. The angle α₁ is preferably at least as great as the angle β₁, and typically it is larger.

FIGS. 6B and 6C show a light ray 18 traveling within the prismatic structure 8f. The surface 16a and the surface 14a may reflect or refract the light ray 18 depending on an incident angle δ₁ (delta) or δ₂ of the light ray 18 with respect to a normal to the surface 16a or the surface 14a. As one of ordinary skill in the art will understand from the present disclosure, selecting different angles α₁ and β₁ allows one to control the angular spread of light transmitted through the prismatic structures 8f of an optical film 6 (e.g., optical film 6a-6e). In some exemplary embodiments, the angles between the opposing pairs of surfaces and a plane parallel to a substrate portion are not equal to each other, which may be advantageous where a viewing axis that is tilted with respect to a normal to the substrate portion is desired.

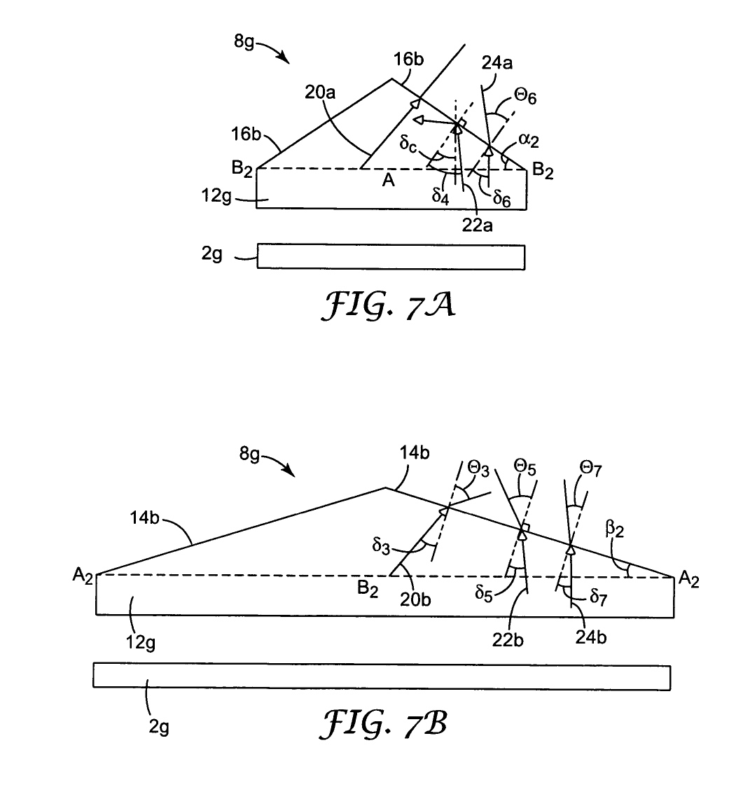

FIG. 7A shows a cross-sectional view of an exemplary embodiment of a prismatic structure 8g similar to the prismatic structure 8f shown in FIG. 6B. A light ray 20a, a light ray 22a, and a light ray 24a, emitted from a backlight 2g, propagate in the prismatic structure 8g. FIG. 7B shows a cross-sectional view of the exemplary embodiment of the prismatic structure 8g similar to the prismatic structure 8f shown in FIG. 6C. A light ray 20b, a light ray 22b, and a light ray 24b, which have the same directions as light rays 20a, 22a, and 24a respectively, shown in FIG. 7A, originate from the backlight 2g and propagate in the prismatic structure 8g.

The following describes the travel of each of the light rays 20-24, originating from the LCD backlight 2g, through the prismatic structures 8g of an optical film 6 of the present disclosure (e.g., optical film 6a-6e). FIGS. 7A and 7B show how a light ray may behave differently depending on whether it first impacts one of the surfaces 16b or one of the surfaces 14b, and how the angular spread of light may be controlled in two separate directions by selecting an angle δ₂ of a surface 16b and an angle δ₂ of a surface 14b. It should be noted that the light rays 20-24 are not drawn to precisely illustrate the angles of reflection and refraction of the light rays 20-24. The light rays 20-24 are only shown to illustrate schematically the general direction of travel of the light rays through the prismatic structure 8g.

In FIG. 7A, the light ray 20a originating from the backlight display 2g travels in the prismatic structure 8g in a direction perpendicular to the surface 16b. Thus, the light ray 20a encounters the surface 16b in a direction perpendicular (or normal) to the surface 16b and an incident angle of the light ray 20a relative to the normal of the surface 16b is equal to zero (0) degrees.

A medium above the optical film 6 (e.g., optical film 6a-6e) and the surfaces 16b and 14b may be, for example, comprised substantially of air. However, the medium above the optical film 6 and the surfaces 16b and 14b may be comprised of any medium, material, or film known to those of ordinary skill in the art. As one or ordinary skill in the art would understand, air has a refractive index less than most known materials. Based on the principles of Snell's Law, when light encounters, or is incident upon, a medium having a lesser refraction index, the light ray is bent away from the normal at an exit angle θ relative to the normal that is greater than an incident angle δ. However, a light ray which encounters a material-air boundary at surface such that it is normal to the surface (e.g., the light ray 20a) is not bent and continues to travel in a straight line as shown in FIG. 7A. Snell's Law can be expressed by the formula:
nᵢ*sin δ=nₜ*sin θ,

where,

nᵢ=the refractive index of the material on the side of incident light,

δ=the incident angle,

nₜ=the refractive index of the material on the side of transmitted light, and

θ=the exit angle.

Those of ordinary skill in the art will understand that a certain amount of the incident light will also be reflected back into the prismatic structure 8g.

FIG. 7B shows the light ray 20b traveling in substantially the same direction as the light ray 20a. The light ray 20b encounters the surface 14b at the incident angle δ₃ relative to a normal to the surface 14b. As discussed above, the angle β₂ of the surface 14b is preferably less than the angle α₂ of the surface 16b. Thus, the incident angle δ₃ of the light ray 20b is therefore not equal to the incident angle δ of the light ray 20a. The incident angle δ₃ of the light ray 20b is not equal to zero (0) as shown in FIG. 7B, and the light ray 20b does not encounter the material-air boundary perpendicular to the surface 14b. The light ray 20b is refracted at an exit angle θ₃ different from the incident angle δ₃ at which it impacted the surface 14b based on the formula of Snell's Law.

As shown in FIG. 7A, the light ray 22a travels into the prismatic structure 8g and encounters the surface 16b at the incident angle δ₄ relative to the normal to the surface 16b. The incident angle δ₄ for the light ray 22a is greater than the critical angle δ_{c} at the surface 16b. The light ray 22a does not exit the prismatic structure 8g and is reflected back into the prismatic structure 8g. This is referred to as “total internal reflection.” As described above, the light ray will behave according to the formula for refraction set forth above when traveling from a material having a higher refractive index to a material having a lower refractive index. According to the formula, the exit angle θ will approach 90 degrees as the incident angle increases. However, at the critical angle δ_{c}, and for all angles greater than the critical angle δ_{c}, there will be total internal reflection (e.g., the light ray will be reflected back into the prismatic structure 8g rather than being refracted and transmitted through the surface). As one of ordinary skill in the art would understand, the critical angle δ_{c} may be determined according to the Snell's Law (described above) by setting the exit angle (e.g., refraction angle) to ninety (90) degrees and solving for the incident angle δ.

As shown in FIG. 7B, the light ray 22b, traveling in substantially the same direction as the light ray 22a, encounters the surface 14b. Because the angle β₂ of the surface 14b is less than the angle α₂ of the surface 16b, the light ray 22b encounters the surface 14b at a different incident angle δ₅ than the incident angle δ₄ at which the light ray 22a encountered the surface 16b. The incident angle of light ray 22b is less than the critical angle δ_{c} and, therefore, the light ray 22b is refracted at the surface 14b and transmitted through the surface 14b.

The light ray 24a and the light ray 24b, shown in FIGS. 7A and 7B respectively, travel in the prismatic structure 8g in a direction perpendicular to the substrate portion 12g. The light rays 24a and 24b encounter the surface 16b and the surface 14b, respectively, at incident angles δ less than the critical angle δ_{c}. However, the incident angle δ₆ of the light ray 24a relative to the normal of the surface 16b is greater than the incident angle δ₇ of the light ray 24b relative to the normal of the surface 14b. Hence, according to Snell's Law, the exit angle θ₆ of the light ray 24a relative to the normal of the surface 16b will be different than the exit angle θ₇ of the light ray relative to the normal to the surface 14b. As one of ordinary skill in the art would understand, the exit angle θ₆ of the light ray 24a relative to the normal of the surface 16b will be greater than the exit angle θ₇ of the light ray 24b relative to the normal of the surface 14b.

As one of ordinary skill in the art would understand, the surface 14b with the lesser angle β₂ may generally “focus” more light toward a direction perpendicular to the backlight 2g than the surface 16b with the greater angle α₂. Thus, the optical film 6 (e.g., optical film 6a-6e) with prismatic structures 8 (e.g., prismatic structures 8a-8g) as described may allow a greater angular spread of light along one direction and a lesser angular spread of light along another direction. For example, the optical film 6 of the present disclosure may be employed in an LCD television to provide a wider angular spread of light in a first direction, e.g., the horizontal direction, and a lesser but still substantial angular spread of light in a second direction, e.g., the vertical direction. This may be advantageous to accommodate the normally wider field of view in the horizontal direction (e.g., viewers on either side of the television) than in the vertical direction (e.g., viewers standing or sitting). In some exemplary embodiments, the viewing axis may be tilted downward, such as where a viewer may be sitting on the floor. By reducing the angular spread of light in the vertical direction, a resultant optical gain may be experienced in a desired viewing angle range.

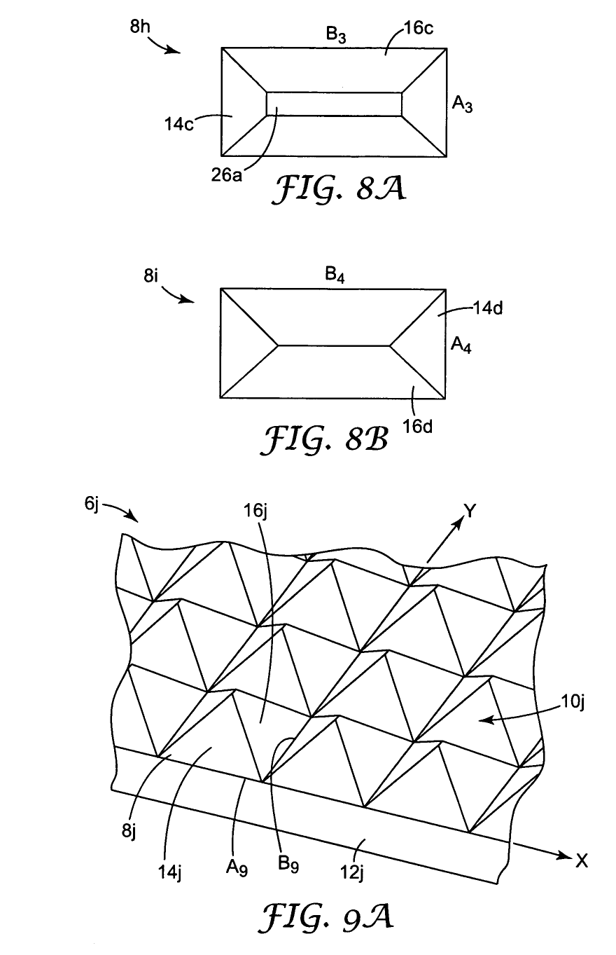

FIGS. 8A and 8B illustrate further exemplary embodiments of the prismatic structures 8 according to the present disclosure. FIG. 8A shows a prismatic structure 8h having two opposing first sides A₃ and two opposing second sides B₃; the length of A₃ is less than the length of B₃. The prismatic structure 8h also includes two surfaces 14c and two surfaces 16c. In this exemplary embodiment, the prismatic structure 8h further includes a substantially flat surface 26a which is, preferably, 5% or less of a groove pitch to minimize gain loss. The flat surface 26a may be useful, for example, when bonding a substrate portion 12 (e.g., substrate portion 12a-12g) or a further film on top of the prismatic structures 8h of the structured surface 10 (e.g., structured surface 10a-10e). Furthermore, the flat surface may aid in transmitting more light in the direction perpendicular to the display (i.e., the direction along which a viewer is likely to view the screen). The surface 26a may be raised or it may be depressed. In some exemplary embodiments, the surface 26a may be rounded.

FIG. 8B shows a prismatic structure 8i having two opposing first sides A₄ and two opposing second sides B₄. In this exemplary embodiment, the two surfaces 14d are of a substantially triangular shape and the two surfaces 16d are of a substantially trapezoidal shape. It is contemplated that the prismatic structure 8i may be of any other construction with two opposing first sides A₄ and two opposing second sides B₄.

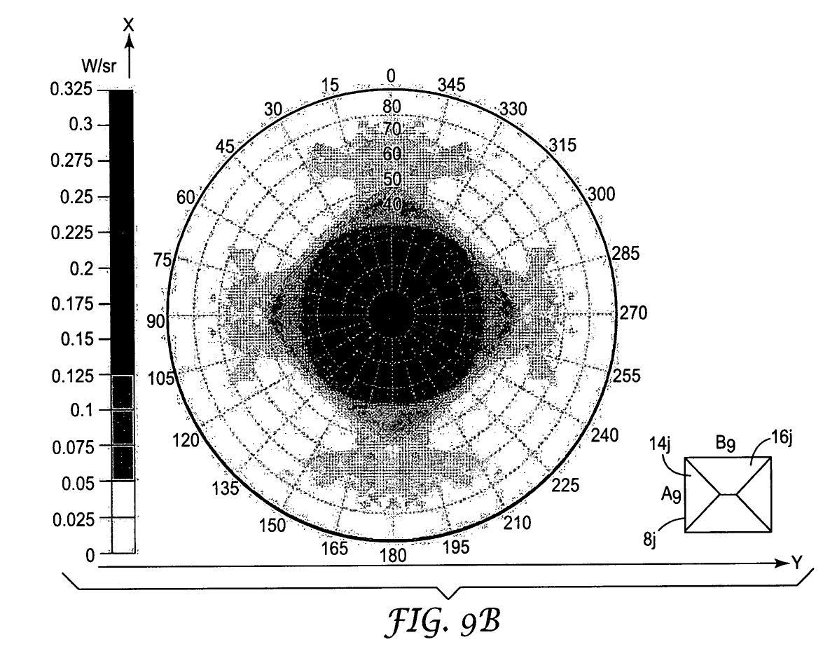

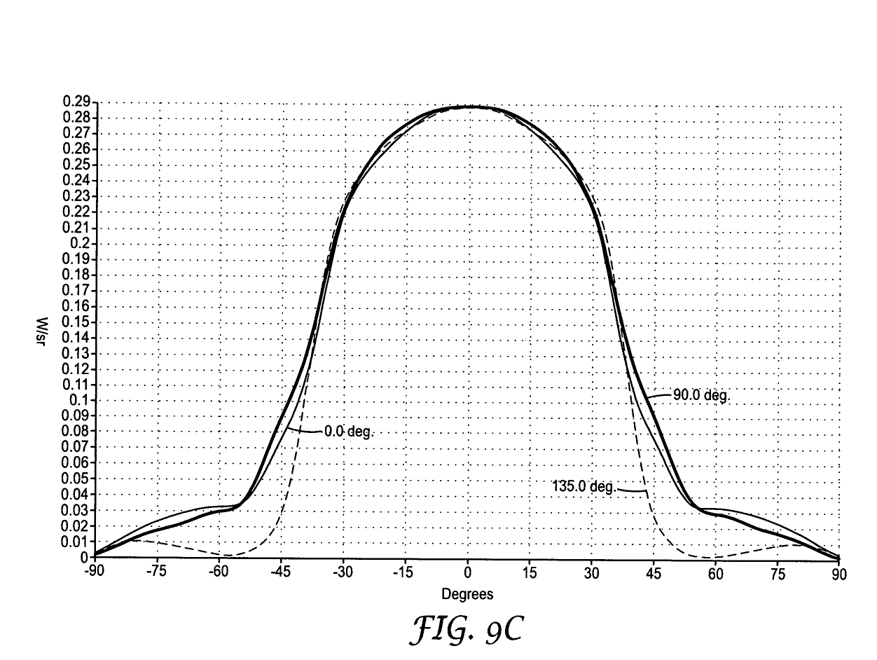

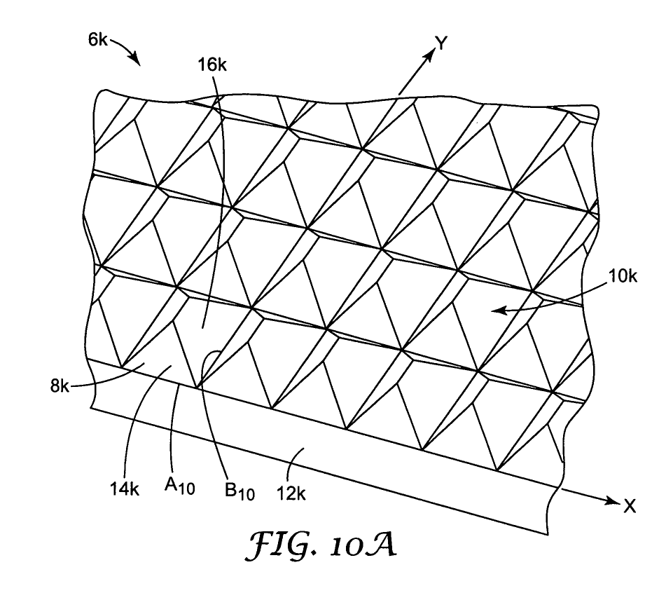

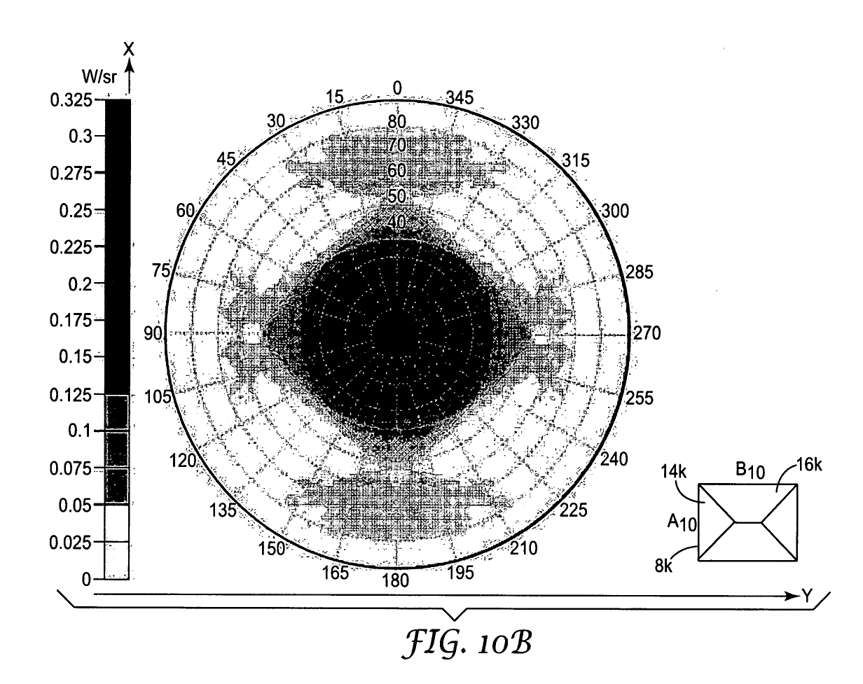

FIGS. 9A, 10A, and 11A show schematic partial perspective views of three additional exemplary embodiments of the optical film 6j, 6k, and 6l, respectively, according to the present disclosure. The exemplary optical films 6j/6k/6l include a portion having a structured surface 10j/10k/10l with a refractive index of approximately 1.58, and a substrate portion 12j/12k/12l having a refractive index of approximately 1.66. The structured surfaces 10j/10k/10l include a plurality of prismatic structures 8j/8k/8l. A base of the prismatic structures 8j/8k/8l may be a four-sided shape with two first sides A₉/A₁₀/A₁₁, disposed generally opposite to each other along a direction Y, and two second sides B₉/B₁₀/B₁₁, disposed generally opposite to each other along a direction X. Each prismatic structure 8j/8k/8l may also include two surfaces 14j/14k/14l and two surfaces 16j/16k/16l. As shown in FIGS. 9A, 10A, and 11A, each of the surfaces 14j/14k/14l meets one of the first side A₉/A₁₀/A₁₁ and each of the surfaces 16j/16k/16l meets one of the second side B₉/B₁₀/B₁₁. The surfaces 16j/16k/16l and 14j/14k/14l in the exemplary embodiments may be situated at a surface angle of about forty-five (45) degrees. The exemplary optical films 6j/6k/6l and prismatic structures 8j/8k/8l are further described in Table 1.

TABLE 1
Optical Films 6j, 6k, 6l

| | 6j | 6k | 6l |
|---|---|---|---|
| Number of Prisms long | 20 | 20 | 20 |
| Number of Prisms wide | 20 | 20 | 20 |
| Prism Length, B (mils) | 2.2 | 2.8 | 6 |
| Prism Width, A (mils) | 2 | 2 | 2 |
| Prism ratio (Length B/width A) | 1.1 | 1.4 | 3 |
| Optical film length (mils) | 44 | 56 | 120 |
| Optical film width (mils) | 40 | 40 | 40 |
| Optical film thickness (mils) | 4 | 4 | 4 |
| Light source length (mils) | 22 | 28 | 60 |
| Light source width (mils) | 20 | 20 | 20 |
| Light source position, length (mils) | 22 | 28 | 60 |
| Light source position, width (mils) | 20 | 20 | 20 |
| Peak light (Watts/steradian) | 0.28857 | 0.28838 | 0.28703 |
| Efficiency (% light flux) | 0.43431 | 0.43065 | 0.43832 |
| Gain | 1.612665 | 1.620833 | 1.60381 |

As shown in Table 1, the variable between the optical films 6j, 6k, and 6l is the length of the second side B₉/B₁₀/B₁₁ of the base of each prismatic structure 8j/8k/8l. The prism ratio in Table 1 is ratio of the length (e.g., B₉/B₁₀/B₁₁) of the base to the width (e.g., A₉/A₁₀/A₁₁) of the base. The gain of each optical film 6j/6k/6l shown in Table 1 is the ratio of the peak axial luminance with the optical film 6j/6k/6l divided to the peak axial luminance of light without the optical film 6j/6k/6l. As one of ordinary skill in the art will understand from Table 1, differences in the prism ratio do not significantly affect the axial gain of the exemplary embodiments of the optical film 6j/6k/6l, while they can produce differences in angular distribution of light exiting the optical films of the present disclosure along two different directions.

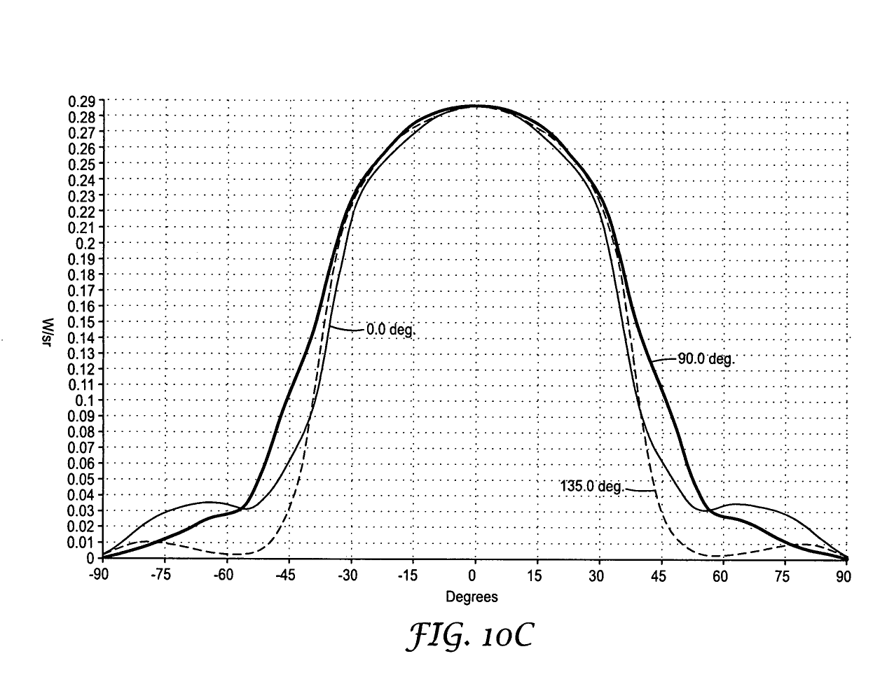

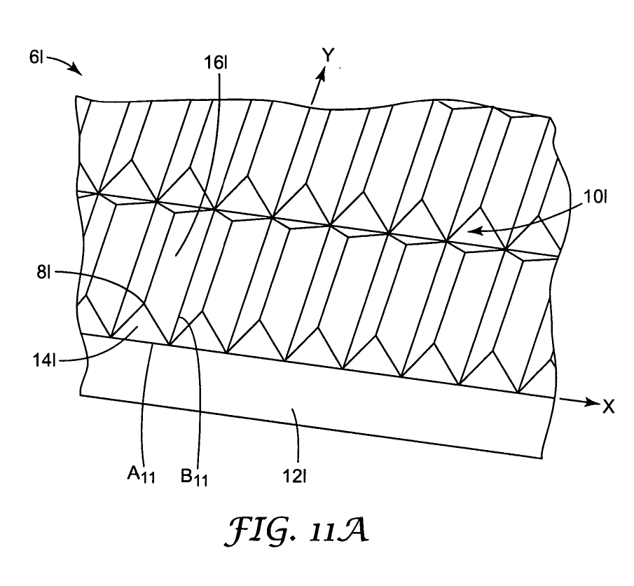

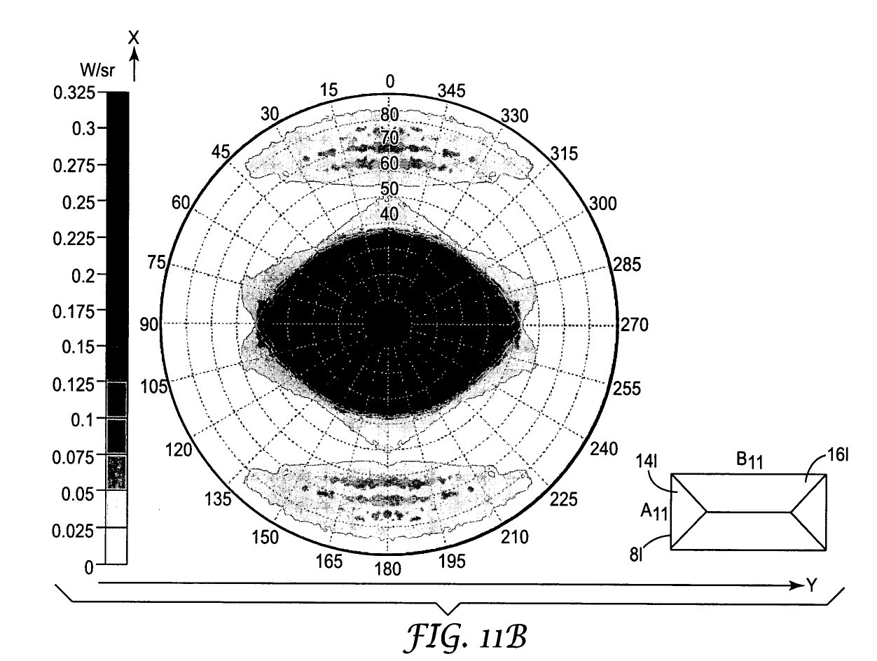

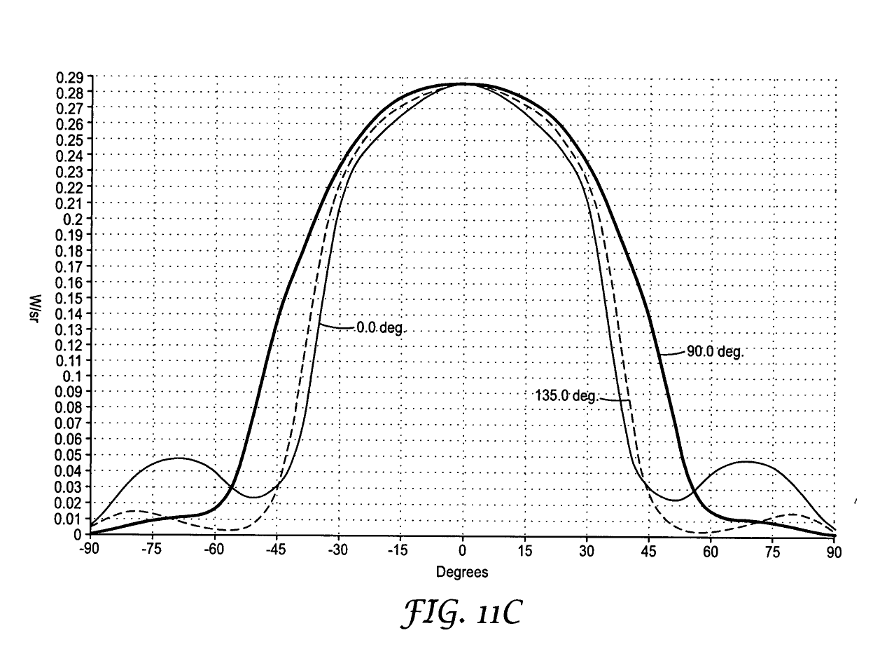

FIGS. 9B, 10B, and 11B show polar iso-candela distribution plots for prismatic structures 8j, 8k, and 8l, respectively. As one of ordinary skill in the art will understand, the candela distribution plots show a three hundred and sixty (360) degree pattern of detected incident light rays having passed through an optical film including prismatic structures, such as prismatic structures 8j/8k/8l of the optical film 6j/6k/6l. An exemplary prismatic structure 8j/8k/8l is shown on each candela distribution plot for directional reference. As shown in FIGS. 9B, 10B, and 11B, the light distribution differs for each of the optical films 6j/6k/6l. For example, the plot for the optical film 6j shown in FIG. 9B, which has the smallest prism ratio, shows a more symmetric distribution (i.e., the distribution of light along the X direction is more similar to distribution along the Y direction than those of FIGS. 10B and 11B). The plot for the optical film 6l shown in FIG. 11B, which has the largest prism ratio of the three embodiments illustrated, shows the least symmetric distribution of the three (i.e., the distribution of light along the X direction is less than the distribution of light along the Y direction).

As one of ordinary skill in the art will understand, the polar iso-candela distribution plots shown in FIGS. 9B, 10B, and 11B demonstrate the ability of the exemplary embodiments to control the distribution of light along two different directions. As discussed above, this may be useful, for example, in devices such as LCD TVs or monitors to provide an extended viewing angle in one direction in a continuous manner.

FIGS. 9C, 10C, and 11C show rectangular candela distribution plots each corresponding to the polar plots shown in FIGS. 9B, 10B, and 11B for the prismatic structures 8j/8k/8l respectively. As one of ordinary skill in the art will understand, the rectangular candela distribution plots show the light intensity through the optical film 6j/6k/6l at different angles. Each curve on the rectangular distribution plots corresponds to a different cross-section of the respective polar plot. For example, the curves designated as 0 degrees represent the cross-section of the polar plots along the line passing through the center that connects 0 and 180 degrees, the curves designated as 90 degrees represent the cross-section of the polar plots along the line passing through the center that connects 90 and 180 degrees, and the curves designated as 135 degrees represent the cross-section of the polar plots along the line passing through the center that connects 135 and 315 degrees. As in the previous set of graphs, the plots for the optical film 6l shown in FIG. 11C, which has the largest prism ratio of the three embodiments illustrated, show the least symmetric distribution of the three (i.e., the distribution of light along the 0 degree direction is less than the distribution of light along the 90 degree direction).

It will be apparent to those skilled in the art that various modifications and variations can be made in the structure and the methodology of the present disclosure, without departing from the spirit or scope of the invention. Thus, it is intended that the present disclosure cover the modifications and variations of the exemplary embodiments described herein, provided that they come within the scope of the appended claims and their equivalents.

What is claimed is:

1. An optical film, comprising:
a body having an axis and a structured surface including a plurality of prismatic structures, each prismatic structure having a base including at least two longer sides disposed opposite to each other along a first general direction and at least two shorter sides disposed opposite to each other along a second general direction,
wherein the body transmits a substantial portion of light incident thereon along the first general direction when an angle of incidence is within a first predetermined angle range with respect to the axis and reflects a substantial portion of light when the angle of incidence is outside the first predetermined angle range, and
wherein the body transmits a substantial portion of light incident thereon along the second general direction when an angle of incidence is within a second predetermined angle range with respect to the axis and reflects a substantial portion of light when the angle of incidence is outside the second predetermined angle range; and
the body comprises a substrate portion having an additional optical characteristic different from an optical characteristic of the structured surface.

2. The optical film according to claim 1, wherein the base has a substantially rectangular shape.

3. The optical film according to claim 1, wherein each prismatic structure is arranged in a substantial contact with at least one other prismatic structure.

4. The optical film according to claim 1, wherein the bases of the plurality of prismatic structures are aligned with the two longer sides of each of the bases extending along the first general direction substantially parallel to one another.

5. The optical film according to claim 1, wherein the substrate portion comprises at least one of: a polarizer film, a diffuser film, a brightness enhancing film, and a turning film.

6. The optical film according to claim 1, wherein the structured surface is disposed on a body portion that is different from the substrate portion, said substrate portion and the body portion are attached to each other.

7. The optical film according to claim 6, wherein the body portion and the substrate portion each have a refractive index, the refractive index of the body portion being lower than the refractive index of the substrate portion.

8. The optical film according to claim 1, wherein the structured surface is disposed on the substrate portion.

9. The optical film according to claim 1, wherein each of the prismatic structures includes at least four surfaces, each of the four surfaces being attached to the base.

10. The optical film according to claim 9, wherein at least four surfaces meet.

11. The optical film according to claim 9, wherein two of the at least four surfaces meet.

12. The optical film according to claim 1, wherein each of the prismatic structures comprises five surfaces, four surfaces being attached to the base, a fifth surface being adjacent to the four surfaces and situated substantially parallel to the base.

13. The backlight display device according to claim 1, wherein the first predetermined angle range is greater than the second predetermined angle range.

14. A display device comprising:
a case having a window;
a backlight situated in the case,
an optical film situated between the backlight and the window, and
a light valve arrangement situated between the optical film and the optical window;
wherein the optical film includes a body having an axis and a structured surface including a plurality of prismatic structures, each prismatic structure having a base including two longer sides disposed opposite to each other along a first general direction and two shorter sides disposed opposite to each other along a second general direction,
wherein the body transmits a substantial portion of light incident thereon along the first general direction when an angle of incidence is within a first predetermined angle range with respect to the axis and reflects a substantial portion of light when the angle of incidence is outside the first predetermined angle range,
wherein the body transmits a substantial portion of light incident thereon along the second general direction when an angle of incidence is within a second predetermined angle with respect to the axis and reflects a substantial portion of light when the angle of incidence is outside the second predetermined angle range, and
wherein the body further comprises a substrate portion having an additional optical characteristic different from an optical characteristic of the structured surface.

15. The backlight display device according to claim 14, wherein the backlight panel is side lit.

16. The backlight display device according to claim 14, wherein the backlight panel is direct lit.

17. The backlight display device according to claim 14, wherein the light valve arrangement is a liquid crystal display panel.

18. The backlight display device according to claim 14, wherein the base of the prismatic structure has a substantially rectangular shape.

19. The backlight display device according to claim 14, wherein each prismatic structure is arranged in a substantial contact with each other.

20. The backlight display device according to claim 14, wherein the rectangular bases of the plurality of prismatic structures are aligned with the two longer sides of each of the bases extending along the first general direction substantially parallel to one another.

21. The backlight display device according to claim 14, wherein the substrate portion comprises at least one of a polarizer film, a diffuser film, a brightness enhancing film, and a turning film.

22. The optical film according to claim 14, wherein the structured surface is disposed on a body portion that is different from the substrate portion, said substrate portion and the body portion are attached to each other.

23. The optical film according to claim 22, wherein the body portion and the substrate portion each have a refractive index, the refractive index of the body portion being lower than the refractive index of the substrate portion.

24. The backlight display device according to claim 14, wherein the structured surface is dispposed on the substrate portion.

25. The backlight display device according to claim 14, wherein the first predetermined angle range is greater than the second predetermined angle range.

26. An optical film comprising:
a substrate portion; and
a structured surface including a plurality of prismatic structures, each prismatic structure having a substantially rectangular base, first surfaces meeting the rectangular base along a width thereof and second surfaces meeting the rectangular base along a length thereof,
wherein at least one of the surfaces reflects light incident thereon when an angle of incidence is between a first predetermined angle and a first axis parallel to the surface and redirects and transmits light there through when the angle of incidence is between the first predetermined angle and a second axis normal to the surface,
wherein the length of each of the rectangular bases is greater than the width thereof to achieve a selected first orientation relative to the substrate portion of the first surfaces and a selected second orientation relative to the substrate portion of the second surfaces, and
wherein the substrate portion has an additional optical characteristic different from an optical characteristic of the structured surface.

27. The optical film according to claim 26, wherein the first and second orientations are selected to achieve a first light reflection/redirection characteristic along a first dimension of the substrate portion and a second light reflection/redirection characteristic along a second dimension of the substrate portion.

28. The optical film according to claim 27, wherein the first light reflection/redirection characteristic is selected to generate more reflection along a first direction and more redirection along a second direction, the first direction being along the width of the base and the second direction being along the length of the base.

29. The optical film according to claim 26, wherein the rectangular bases of the plurality of prismatic structures are aligned with the lengths of each of the rectangular bases extending along the substrate portion substantially parallel to one another.

30. The optical film according to claim 26, wherein the lengths of the rectangular bases are substantially equal to one another, and wherein the widths of the rectangular bases are substantially equal to one another.

31. The optical film according to claim 26, wherein the substrate portion comprises at least one of a polarizer film, a diffuser film, a brightness enhancing film, and a turning film.
